(19) United States
(12) Patent Application Publication
(10) Pub. No.: US 2010/0126608 A1
(43) Pub. Date: May 27, 2010

(54) LIQUID FERTILIZER, WEED KILLER, AND PESTICIDE APPLICATION DEVICE USING EXCHANGEABLE CONTAINERS CONNECTED TO A HOSE BIB

(76) Inventor: Theo Duncan, Auburn, CA (US)

Correspondence Address: Russ Weinzimmer, 614 Nashua Street, Suite 53, Milford, NH, 03055, US

(21) Appl. No.: 12/624,301

(22) Filed: Nov. 23, 2009

Related U.S. Application Data
(60) Provisional application No. 61/117,114, filed on Nov. 22, 2008.

(51) Int. Cl. F15D 1/02

(52) U.S. Cl. 137/602

(57) ABSTRACT

An apparatus and method of use are disclosed for introducing botanical treatment liquid into water that is flowing from a hose bib into a hose. The apparatus includes a hose bib adaptor that can be connected to the hose bib with a flex hose and a treatment liquid input port that extends at an at least partly upward angle from the hose bib adaptor. In preferred embodiments, the hose bib adaptor includes a flexible segment to facilitate its adaptability to various configurations of hose bib.

### CROSS-REFERENCE TO RELATED APPLICATIONS

This application claims priority to U.S. Provisional Patent Application 61/117,114, having a filing date of Nov. 22, 2008, which is incorporated herein by reference in its entirety.

### FIELD OF THE INVENTION

The invention generally relates to applying fertilizer, weed killer, pesticides and other liquid botanical treatments, and more specifically to apparatus and methods for applying such treatments through residential hose bib water systems.

### BACKGROUND OF THE INVENTION

In many climates throughout the world, irrigation is required to enable lawns, shrubbery, trees, agricultural crops, and other plant life to survive and flourish. While larger areas of land are frequently watered using in-ground irrigation systems, smaller areas are often watered by hand using a hose connected to a hose bib.

In addition to water, the application of fertilizer, weed killer, pesticides, and other treatment liquids is often desirable to further enhance the health and growth of plant life. For small areas that are irrigated by hand using hoses, devices are well known that attach to the end of a hose and automatically mix fertilizer or another treatment liquid, or dissolving solid, with water flowing from the outlet of the hose. Many of these devices use exchangeable treatment containers and/or containers that minimize or eliminate exposure of the user to the treatment materials. However, these systems require that a user support the weight of the treatment container during application, which can be inconvenient and uncomfortable, can limit the size of the treatment container, and can require frequent exchange of the treatment container.

### SUMMARY OF THE INVENTION

An apparatus and method of use are disclosed for introducing botanical treatment liquid into water that is flowing from a hose bib into a hose. The apparatus includes a hose bib adaptor that can be connected to the hose bib with a flex hose and a treatment liquid input port that extends at an at least partly upward angle from the hose bib adaptor. In preferred embodiments, the hose bib adaptor includes a flexible segment to facilitate its adaptability to various configurations of hose bib.

The claimed apparatus further includes and exchangeable treatment liquid container that can be connected to the treatment liquid input port so as to introduce treatment liquid into water flowing through the hose bib. In various preferred embodiments, the treatment liquid is introduced into the flow of water due to a pressure differential caused by a constriction in the hose bib adaptor, and/or due to a water diverter that protrudes into the flow of water and diverts some of the water through the treatment liquid container.

In preferred embodiments, the apparatus is consumer friendly easy to connect to and disconnect from existing hose bibs, and is compatible with standard hose bib sizes. Preferred embodiments of the apparatus include a hollow replacement cap that can be connected by watertight means to the treatment liquid input port so as to seal the treatment liquid input port when a treatment liquid container is not connected thereto.

In further preferred embodiments the treatment liquid container connects to the treatment liquid input port by means of a threaded connection and a sealing washer and/or the treatment liquid container is made from plastic and/or is disposable. In still further preferred embodiments, the treatment liquid container contains the treatment liquid in an inner collapsible bag or membrane, thereby allowing either the container itself (in the first instance) or the bag or membrane (in the second instance) to collapse as treatment liquid contained therein enters the hose system.

In some preferred embodiments where the treatment liquid container Is pre-filled with liquid fertilizer, weed killer, pesticide, or another botanical treatment liquid, it is a/so sealed by a penetrable membrane, and in some of these embodiments the treatment liquid input port includes at least one protrusion that penetrates the membrane when the treatment liquid container is attached, thereby allowing the pre-filled liquid to flow into the water pipe adaptor. In some of these embodiments, the protrusion is part of a barrier inside of the treatment liquid input port, and there is a hole near the tip of the protrusion that allows treatment liquid to flow from the treatment liquid container through the hole and into the hose bib adaptor at a desired rate.

In preferred embodiments, the treatment liquid input port of the hose bib adaptor Includes a barrier that is penetrated by at least one treatment hole, so as to allow treatment liquid to flow from the treatment liquid container though the hole and Into the hose at a desired rate. In some of these embodiments the desired rate causes the entire volume of the treatment liquid container to enter the hose and become depleted. In some preferred embodiments, the treatment liquid container has a capacity of 12 to 64 oz.

In preferred embodiments a constriction is included in the hose bib adaptor. The constriction divides the water flow into an upstream region and a downstream region, and causes the water pressure to be higher In the upstream region then in the downstream region when water flows through the hose bib adaptor. A water inlet channel is included that allows water to flow from the upstream region into the treatment liquid container, and a treatment liquid outlet channel is included that is configured so as to allow treatment liquid to flow from the treatment liquid container into the downstream region. In some of these embodiments the constriction is a tapered constriction with an inner opening that varies over the length of the constriction, while in other of these embodiments the constriction is and annular constriction. In certain of these embodiments the treatment liquid container includes a collapsible treatment liquid compartment that is configured so as to collapse and thereby dispense treatment liquid into the treatment liquid outlet channel when water flows from the water inlet channel into a space within the treatment liquid container that surrounds the collapsible treatment liquid compartment. In various of these embodiments the water inlet channel and/or the treatment liquid outlet channel is able to penetrate a membrane sealing the treatment liquid container when the treatment liquid container is attached to the treatment liquid input port. And in other of these embodiments a water inlet diverter is included that is located within the upstream region and configured so as to intercept a portion of the water flowing though the applicator device and divert the portion of the water into the water inlet channel.

The method of the invention includes providing an apparatus as described above, including a treatment liquid container that Is at least partly filled with treatment liquid, connecting the hose bib adaptor in series with a flexible high pressure hose, or braided stainless Steele with flexible PVC core that is bonded, clamped, or molded, and is connecting the treatment liquid container to the treatment liquid container port, and operating the applicator system, so as to cause treatment liquid to be combined with water and applied to plant life served by the hose bib connection system.

### BRIEF DESCRIPTION OF THE DRAWINGS

The invention will be more fully understood by reference to the detailed description, in conjunction with the following figures, wherein:

FIG. 1A is a side view of a preferred embodiment that includes a constriction to divert water through the liquid treatment container, and structural reinforcements that enhance the ability of the treatment liquid input port to support the weight of the treatment liquid container;

FIG. 1B is an expanded view of the constriction and input and output ports of FIG. 1A that divert water through the treatment liquid container;

FIG. 2 is a perspective view of a flexible, pressure reinforced segment that connects a hose bib adaptor to a hose bib in a preferred embodiment;

FIG. 3A is a cross sectional view of an embodiment that includes structural reinforcements similar to FIG. 1, a constriction that creates a pressure differential so as to divert water through the treatment liquid container, and a water diverter configured so as to direct water through the treatment liquid container;

FIG. 3B is a cross sectional view of an embodiment similar to FIG. 3A, but having structural reinforcements which can accommodate insertion of a treatment liquid container perpendicular to the alignment of the hose;

FIG. 4 is a cross sectional view of the embodiment of FIG. 3A showing the constriction and water diverter;

FIG. 5A is a side view that illustrates the flow of water and treatment liquid through the embodiment of FIG. 1A;

FIG. 5B is a side view that illustrates the flow of water and treatment liquid in an embodiment that is similar to the embodiment of FIG. 1A, except that the treatment liquid is contained in a collapsible compartment such that treatment liquid flows into the irrigation system as water fills the space surrounding the collapsible compartment and applies pressure to the collapsible compartment;

FIG. 5C is a side view of an embodiment similar to the embodiment of FIG. 1A, wherein the distal ends of the connecting tubes are adjacent and protrude into the treatment liquid input port such that they are able to penetrate a penetratable membrane that seals the treatment liquid container;

FIG. 5D is a side view of the embodiment of FIG. 1A, with a partly hollow sealing plug installed that seals the apparatus when not in use while providing space for the protruding ends of the connecting tubes;

FIG. 6 is a side view of an embodiment that supports the treatment liquid container in a vertical orientation;

FIG. 7 is a side view of an embodiment that provides for the weight of the treatment liquid container to be supported by a stand resting on the ground; and

FIG. 8 is a side view of an embodiment wherein the treatment liquid container is supported by the hose bib adaptor without structural reinforcement, showing a garden hose and spray nozzle coordinate with the present invention.

### DETAILED DESCRIPTION OF PREFERRED EMBODIMENTS

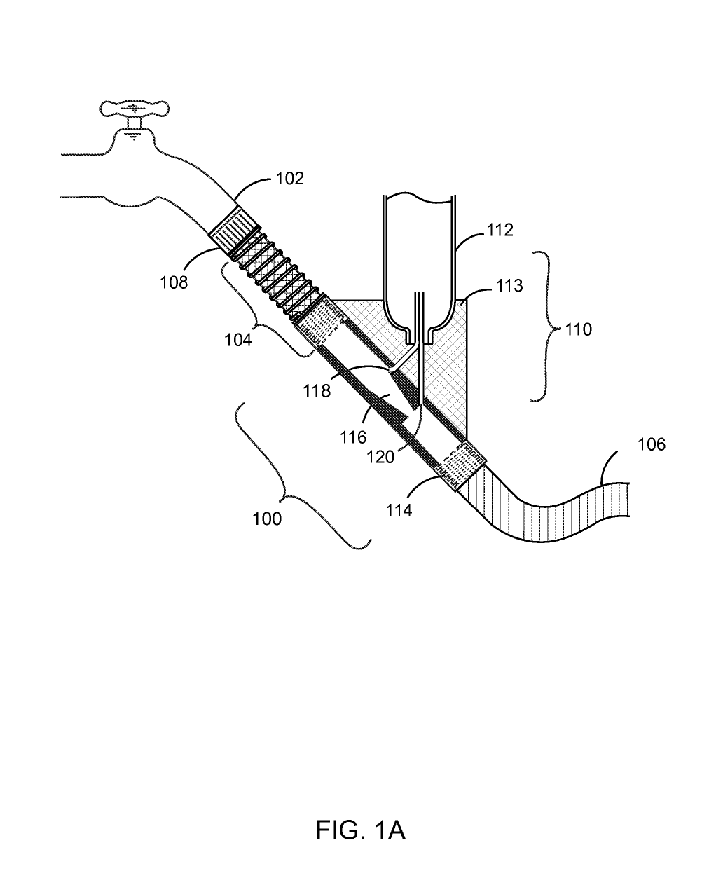

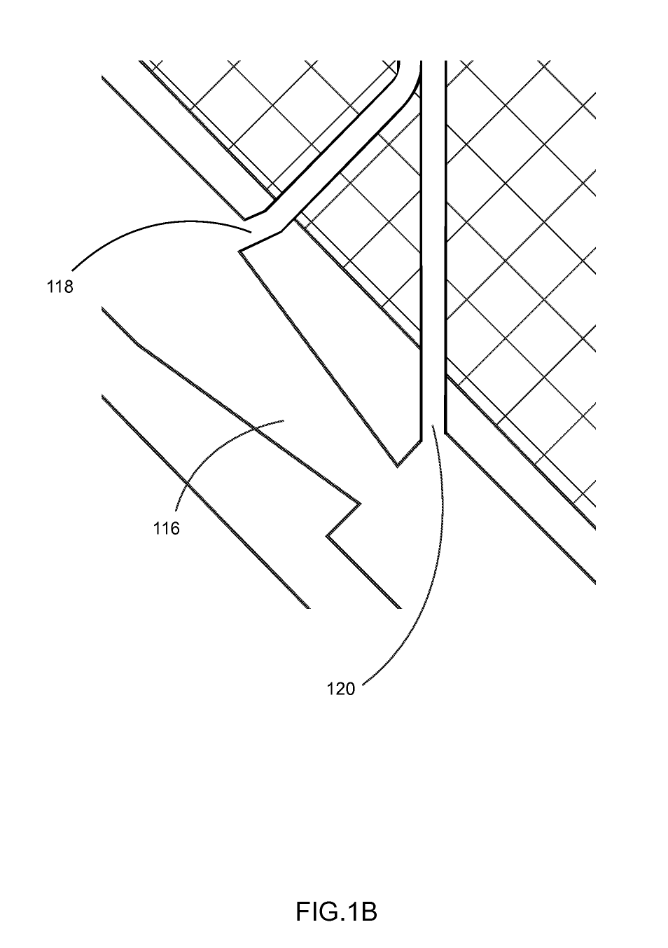

With reference to FIG. 1A, the present invention is an apparatus for applying botanical treatment liquid from a hose bib that is easy to use and low in cost. The apparatus includes a hose bib adaptor 100 connectable in series between a hose bib 102 and a garden hose 106, a treatment liquid input port 110 extending either horizontally outward, or at least partly upward, from the hose bib adaptor 100; and an exchangeable treatment liquid container 116 that is connectable by watertight means to the treatment liquid input port 110 so as to cause treatment liquid located in the treatment liquid container 116 to flow into the hose bib adaptor 100. In the embodiment of FIG. 1A, the hose bib adaptor includes structural reinforcement 113 that helps to support the weight of the treatment liquid container 116.

The hose bib adaptor 100 is easily detached from a hose bib 102, either for storage of the apparatus or for portability for use with other hose bibs 102. Also, by introducing the treatment liquid near the hose bib 102, the present invention provides for thorough mixing of the liquid treatment with water as the water and liquid treatment flow through a hose before application.

The embodiment of FIG. 1A includes a constriction 116 and a water diverter 118 in the hose bib adaptor 100 that serve to divert some of the water flowing through the adaptor 100 so that it flows through the treatment liquid container 116 and thereby mixes with treatment liquid and transports the treatment liquid back into the water flow in the garden hose 106. This can be seen more clearly in the expanded view of FIG. 1B. The constriction 116 causes a pressure difference between an upstream region and a downstream region, so that the pressure is higher at the treatment liquid input port 118 that it is at a treatment outlet port 120. The shape of the treatment input port 118 is configured so as to divert water into the treatment liquid container 116, thereby further increasing the flow of water through the treatment liquid container 116.

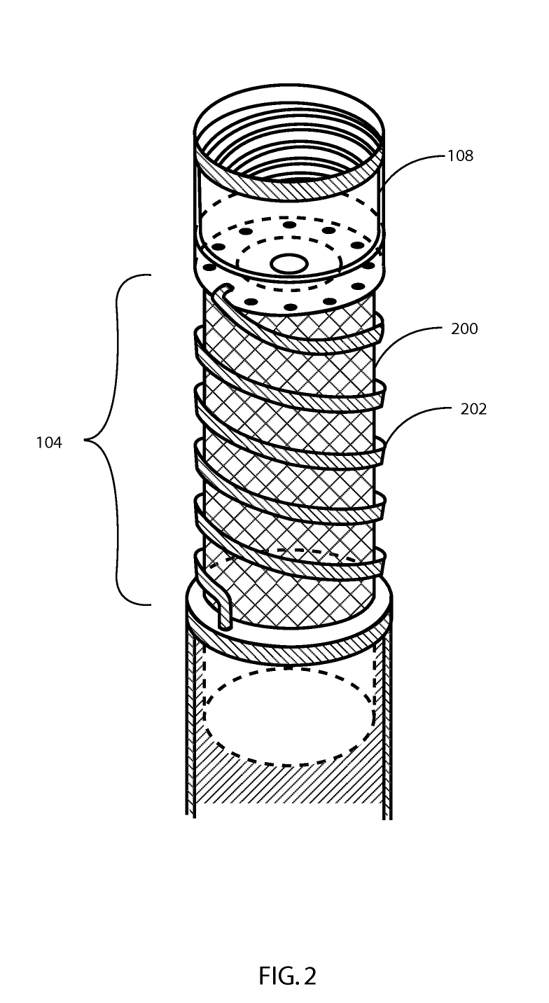

FIG. 2 is a side perspective view of a flexible, reinforced segment 104 included in the embodiment of FIG. 1A that connects the hose bib adaptor to the hose bib. The pressure reinforced segment includes a braided flex steel high pressure hose segment 200 and a metal flex spring 202 wrapped around the segment 200 so as to adapt the segment 200 to high water pressure. Other suitable materials will occur to one skilled in the art. A top end of the metal spring 202 is bent and adapted to fit into any of a series of notches or holes surround is attached to a hose bib connector 108 adapted to surround a female hose bib. The hose bib connector 108 can be made of metal, such as brass, or other durable material such as PVC or ABS. The ability of the top end of the metal spring 202 into any of these holes allows for 360 degree rotation of the adaptor 100. The other end of the reinforced segment 200 is firmly attached to the hose bib adaptor 100 in a fixed position. After attachment of the reinforced segment 200 to the hose bib 102, the top bent end of the metal spring 202 can be inserted into one of the notches or holes in a hose bib connector 108 configured to surround the hose bib 102, so as to fix the angular orientation of the reinforced segment 104 and hose bib adaptor so as to keep them from rotating about the hose bib connector 108.

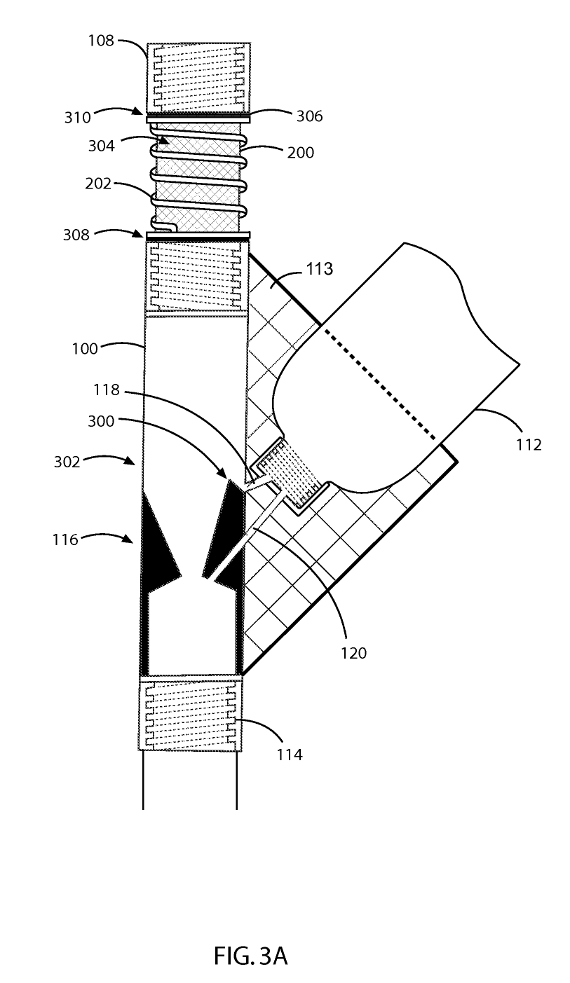

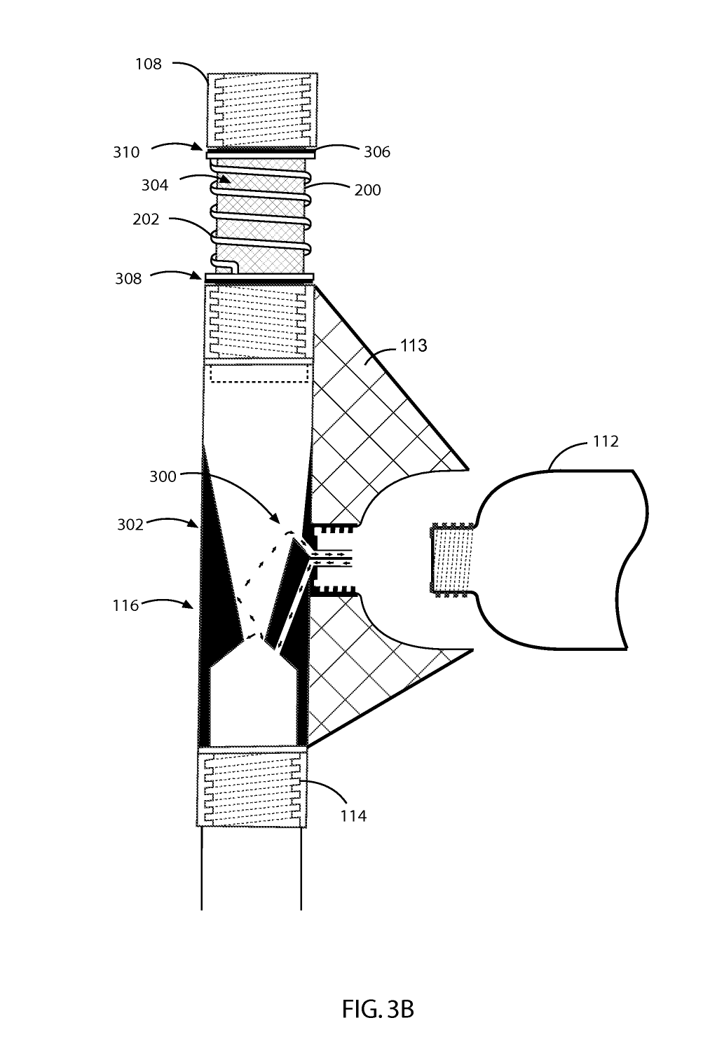

FIG. 3 is a cross sectional side view of an embodiment similar to the embodiment of FIG. 1A, but with a slightly different design that incorporates the water flow diverter 300 into the upstream end 302 of the constriction 116. A high pressure hose 200, including braided metal in some embodiments, surrounds a flexible pipe 302 made from ABS or PVC, or other tubing. A female hose connector 108 made preferentially from brass or another metal, includes a rubber washer 306 so as to make a leak-tight seal with a hose bib. A flexible spring 202 surrounds the high pressure hose 200, and is bonded, clamped, molded, threaded, or otherwise fixed at one end to an end 204 of the hose bib adaptor 100. The other end of the flexible spring 202 is insertable into a hole, slot, or other opening in the hose bib connector 108 so as to resist rotation of the hose bib adaptor 100 relative to the hose bib. At the other end of the hose bib adaptor 100 a male hose connector 114, preferably made from bonded brass, metal, or plastic, provides for connection to a garden hose.

Water is diverted from the hose bib adaptor 100 into the treatment liquid container 112 by a pressure differential between an inlet channel 118 and an outlet channel 120. The pressure differential is caused by a constriction 116 that creates a higher pressure area at its upstream end and a lower pressure area at its down stream end. Water is also diverted into the inlet channel 118 by a water flow diverter 300 that physically intercepts and diverts water from the main flow.

In some embodiments (not shown) various mechanisms are included that can be used to control the rate at which water flows through the treatment liquid container 112. In some of these embodiments, one or both of the inlet channel 118 and the out let channel 120 is exchangeable, allowing channels with different inner diameters to be selected. In other embodiments, a valve is included in either or both of the inlet channel 118 and the outlet channel 120, allowing the flow to be controlled or even stopped. Use of such a valve or valves can also be used to close one or both of the channels 118, 120, thereby allowing a treatment liquid container 112 to be used on multiple occasions without removal. If valves are included in both the inlet channel 118 and the outlet channel 120, closing of both valves allows the hose to be used without a treatment liquid container 112 being installed. For example, a manual valve can be included which, when turned in the open position, introduces a washer or other temporary constriction which can cause the pressure differential necessary to introduce the fertilizer solution from the liquid treatment container 112 into the hose bib adaptor. When the manual valve is in the closed position, on the other hand, the washer is not introduced, and thus only water from the hose bib flows through the adaptor.

In some embodiments, an insert made of rubber or other suitable material can be inserted into the neck of the liquid treatment container 112, to act as a stopper to prevent liquid treatment from spilling out of the liquid treatment container 112 during insertion of the liquid treatment container 112 onto the channels 118, 120 connected to the adapter. The insert can have small holes extending longitudinally through the insert, so as to accommodate the channels 118, 120 of the adapter, but so as not to allow liquid treatment to spill from the liquid treatment container 112 before insertion of the liquid treatment container 112.

FIG. 3B is a cross sectional view of an embodiment similar to FIG. 3A, but having structural reinforcements which can accommodate insertion of a treatment liquid container perpendicular to the alignment of the hose bib adapter 100.

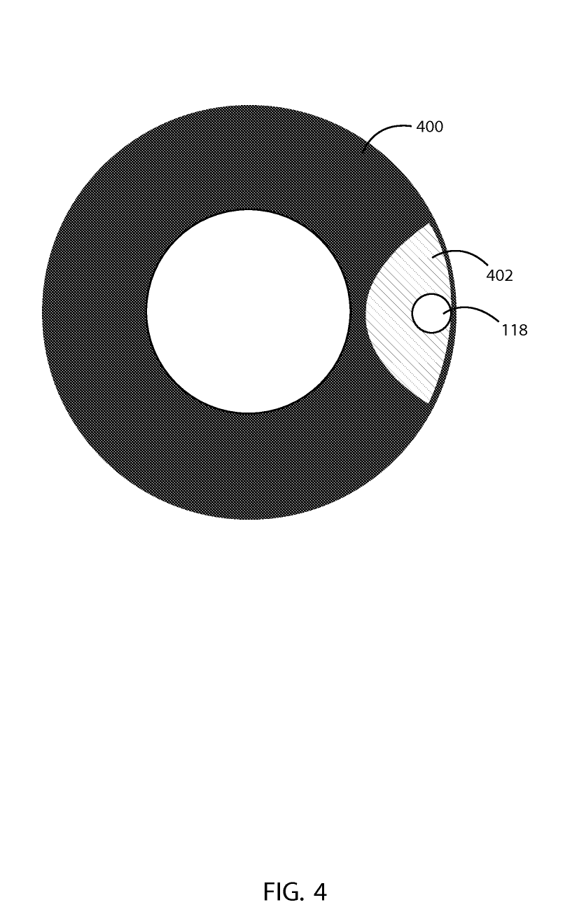

A cross section of the embodiment of FIG. 3 taken through the water flow diverter 807 at right angles to FIG. 3 is shown in FIG. 4.

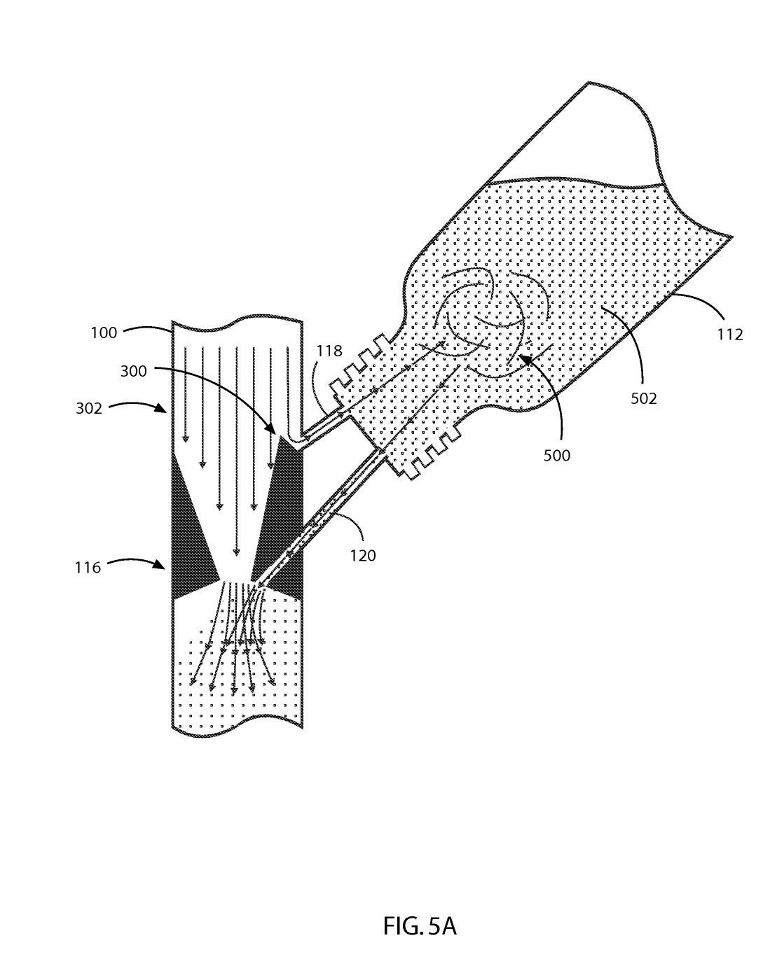

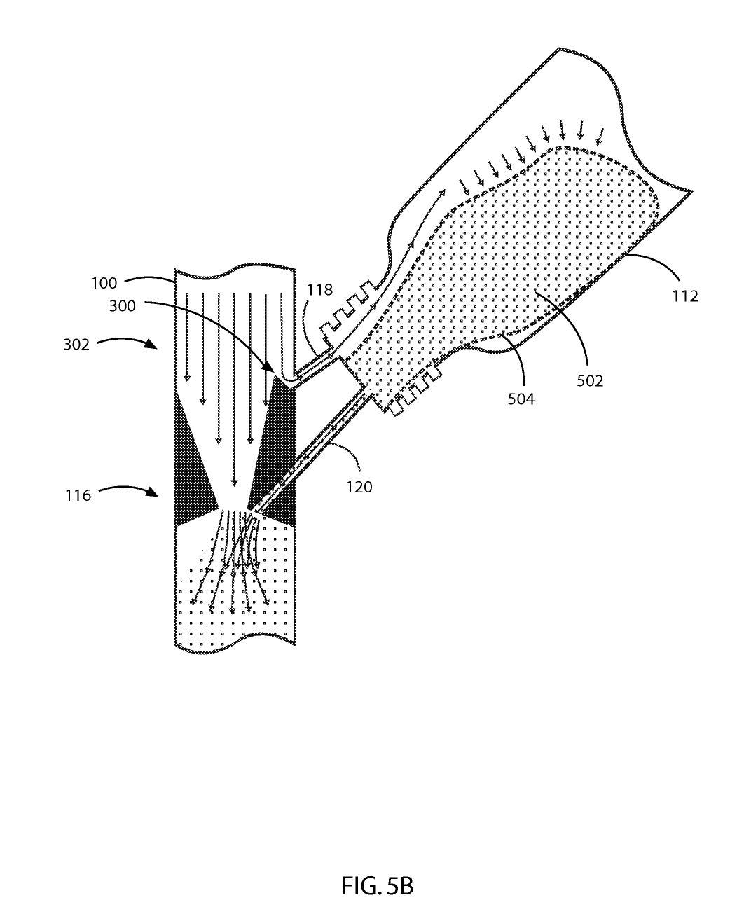

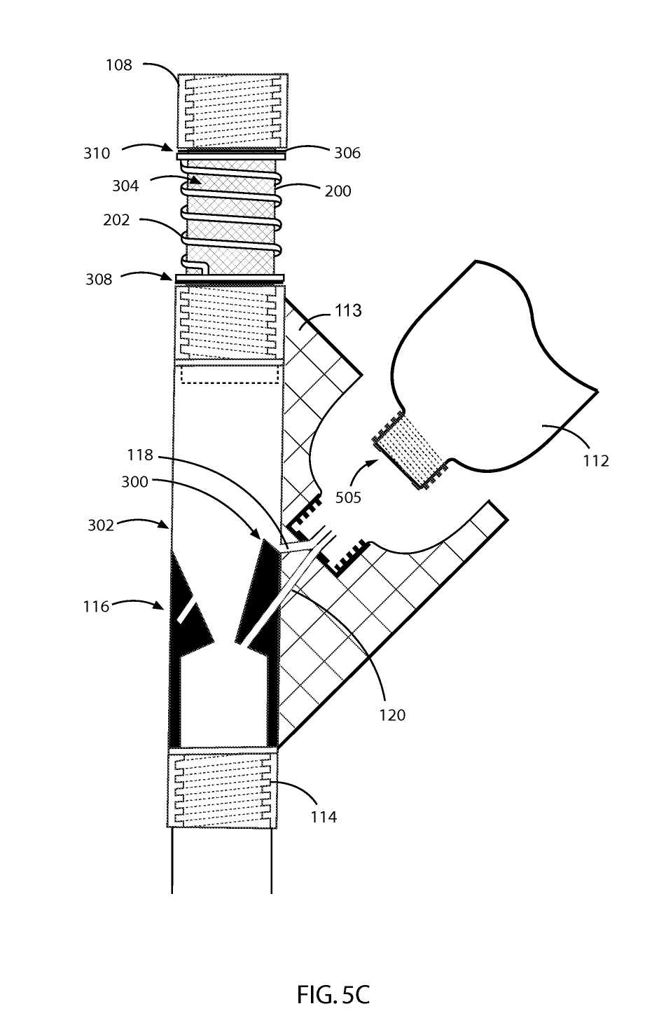

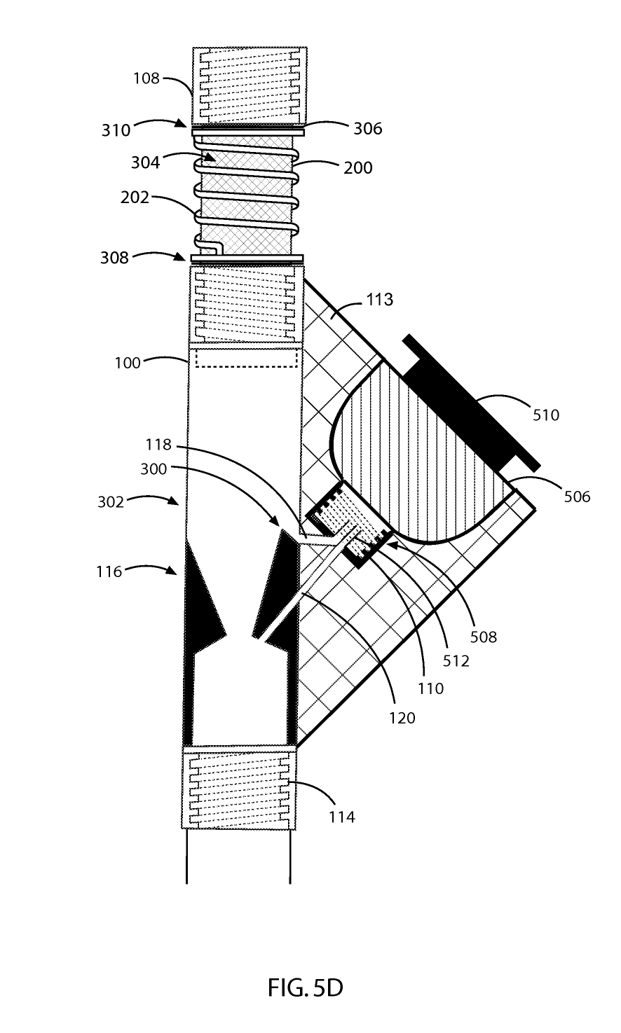

FIG. 5A illustrates the flow of water through an embodiment similar to FIG. 1A. As water flows through the restriction 116, some of the water by-passes the restriction 116 and flows instead from the high water pressure area upstream of the constriction 116 into the water diverter 300, through the water inlet tube 118, and into the treatment liquid container 112. There the water mixes 500 with the treatment liquid 502 and increases the liquid pressure inside of the treatment liquid container 112. This causes a mixture of water and treatment liquid to leave the treatment liquid container 112 through the treatment liquid outlet tube 120 and flow into the lower pressure area of the water pipe adaptor 100 downstream of the constriction 116. The process continues until the treatment liquid container 112 is fully diluted with water, and all of the treatment liquid 502 has been extracted from the treatment liquid container 112. In some embodiments, the treatment liquid container 112 is transparent and the treatment liquid 502 is colored and/or at least partly opaque. In these embodiments, the color of the liquid in the treatment liquid container 112 can be seen to gradually turn clear as the treatment liquid 502 is diluted until none is left in the treatment liquid container 112. The treatment liquid container 112 can then be removed and discarded, and a replacement cap can be installed in its place.

FIG. 5B illustrates the flow of water in a preferred embodiment similar to the embodiment of FIG. 5A, except that the treatment liquid 502 is contained in a flexible bag 504, such that water entering the treatment liquid container 112 through the water inlet tube 118 is not mixed with the treatment liquid 502, but instead fills the space between the flexible bag 504 and the treatment liquid container 112, thereby applying pressure to the flexible bag 502 and forcing treatment liquid 502 through the treatment liquid outlet tube 120 and into the lower pressure area of the water pipe adaptor 302 downstream of the constriction 116. The process continues until all of the treatment liquid has been extracted from the treatment liquid container 112, at which point the empty flexible bag 504 seals the treatment liquid exit tube 120 and stops the flow of water through the treatment liquid container 112.

FIG. 5C is a side view of an embodiment with the treatment liquid container 112 removed. The embodiment is similar to the embodiment of FIG. 5A, except that the distal ends of the water inlet tube 118 and the treatment liquid outlet tube 120 both terminate in adjacent hollow points 812 that protrude into the treatment liquid input port and are able to penetrate a membrane 505 that seals the treatment liquid container 112. This allows the treatment liquid container 112 to be conveniently installed without a user coming into contact with the treatment liquid. In various embodiments, the membrane 505 is made from coated paper, rubber, plastic, or a similar material, and can include scoring to facilitate penetration by the protruding hollow points of the inlet and outlet tubes 118, 120. A washer 505 similar to a common garden hose washer forms a water-tight seal between the treatment liquid container 112 and the treatment liquid input port.

FIG. 5D is a side view of the embodiment of FIG. 5C configured with a cap 506 installed in the treatment liquid port so as to seal the treatment liquid input port when not in use. The threaded area 508 of the cap 506 is hollow, so as to make space for the adjacent hollow points 512 at the distal ends of the water inlet tube 118 and the treatment liquid outlet tube 120 that protrude into the treatment liquid input port.

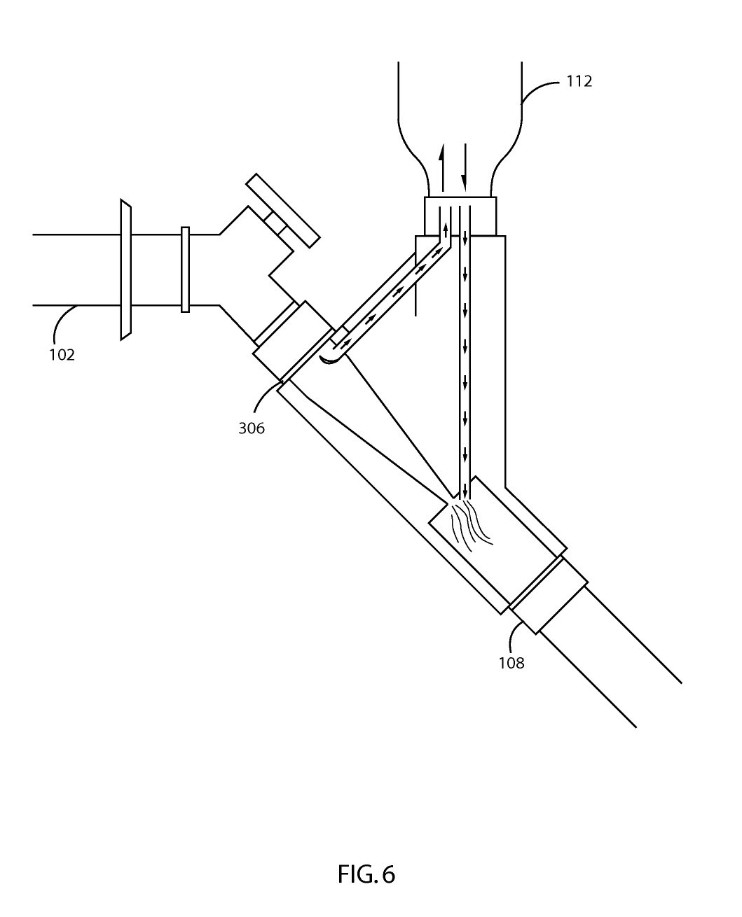

FIG. 6 is a side view of an embodiment that supports the treatment liquid container in a vertical orientation.

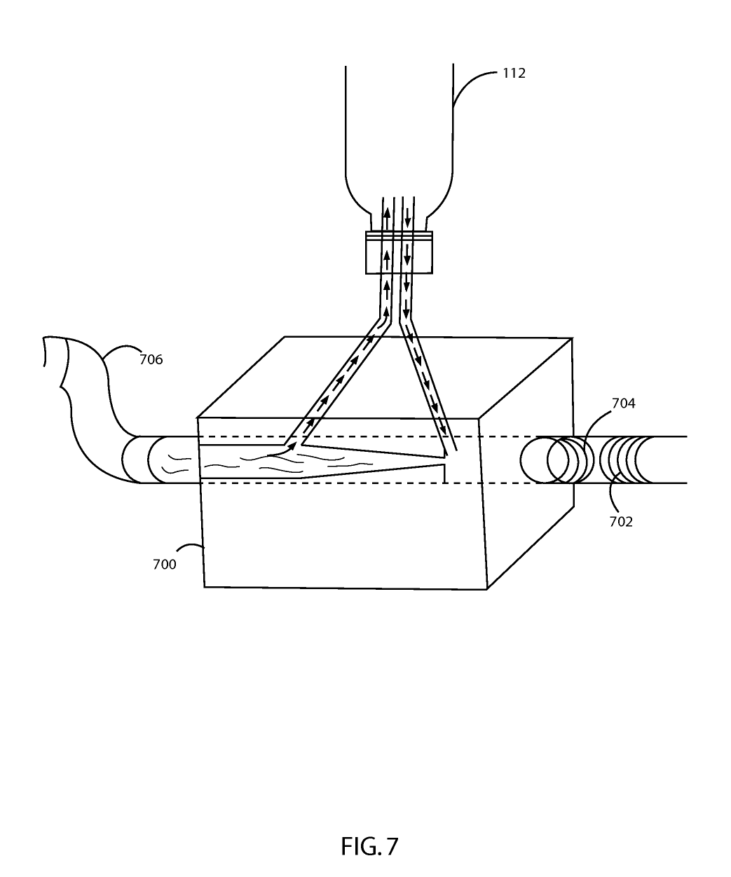

FIG. 7 is a side view of an embodiment that includes a stand 700 that supports the weight of the treatment liquid container 112 from the ground. The stand 700 can be configured so as to support the treatment liquid container 112 either vertically, as shown, or at an angle. In preferred embodiments, the treatment liquid container 112 is oriented either at a 90 degree angle relative to the adapter, or a 45 degree angle relative to the adapter. In some preferred embodiments, the liquid treatment container 112 can fit inside the stand 700. In other preferred embodiments, the liquid treatment container 112 can also be capped off, as also discussed in connection with FIG. 5D. This embodiment is especially suited for larger treatment liquid containers weighing 64 ounces or more.

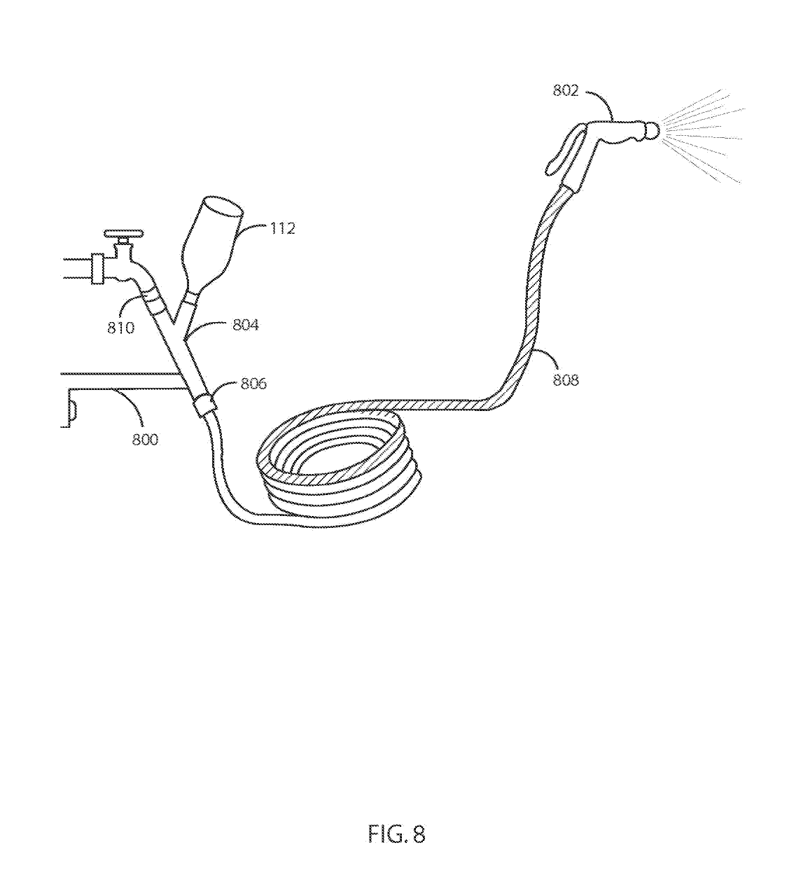

FIG. 8 is a side view of an embodiment wherein the treatment liquid container 112 is supported by the hose bib adaptor 804 without structural reinforcement. The figures shows a garden hose 808 and spray nozzle 802 in cooperation with the present invention. A wall-mounted structural support 800 is shown supporting the hose bib adaptor 804.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for applying botanical treatment liquid from a hose bib that is easy to use and low in cost, the apparatus comprising:
a hose bib adaptor connectable in series between a hose bib and a garden hose;
a treatment liquid input port extending at least partly upward from the hose bib adaptor; and
an exchangeable treatment liquid container, connectable by watertight means to the treatment liquid input port so as to cause treatment liquid located in the treatment liquid container to flow into the hose bib adaptor.

2. The apparatus of claim 1, further comprising a replacement cap, connectible by watertight means to the treatment liquid input port so as to seal the treatment liquid port when a treatment liquid container is not connected thereto.

3. The apparatus of claim 1, wherein the treatment liquid container is connectible to the treatment liquid input port by means of a threaded connection and a sealing washer.

4. The apparatus of claim 1, wherein the treatment liquid container is pre-filled with a liquid that is one of a fertilizer, a weed killer, a pesticide, a degreaser, and other botanical and household treatment liquids.

5. The apparatus of claim 4, wherein the treatment liquid container is sealed by a penetratable membrane, and the treatment liquid input port of the hose bib adaptor includes a protrusion that penetrates the penetratable membrane when the treatment liquid container Is attached to the treatment liquid input port, thereby allowing the pre-filled liquid to flow from the treatment liquid container into the hose bib adaptor.

6. The apparatus of claim 5, wherein the protrusion is part of a barrier inside of the liquid input port, and wherein a hole penetrates the barrier near the tip of the protrusion, thereby allowing the treatment liquid to flow from the treatment liquid container through the hole and into the hose bib adaptor at a desired rate.

7. The apparatus of claim 1, wherein the treatment liquid container includes a collapsible treatment liquid compartment that collapses as liquid contained in the treatment liquid container flows into the hose bib adaptor.

8. The apparatus of claim 1, wherein the treatment liquid input port includes a barrier that is penetrated by at least one treatment hole so as to allow treatment liquid to flow from the treatment liquid container through the hole and into the hose bib adaptor at a desired rate.

9. The apparatus of claim 8, wherein the desired rate causes the entire volume of the treatment liquid container to enter the hose system.

10. The apparatus of claim 1, wherein the treatment liquid container is disposable.

11. The apparatus of claim 1, wherein the treatment liquid container is physically supported by its connection to the treatment liquid input port.

12. The apparatus of claim 11, further comprising structural reinforcements that enhance the ability of the treatment liquid input port to support the weight of the treatment liquid container.

13. The apparatus of claim 1, further comprising:
a constriction in the hose bib adaptor that divides the hose bib adaptor into an upstream region and a downstream region, the constriction causing water pressure to be higher in the upstream region then In the downstream region when water flows through the hose bib adaptor;
a water inlet channel configured so as to allow water to flow from the upstream region into the treatment liquid container when the treatment liquid container is connected to the treatment liquid input port; and
a treatment liquid outlet channel configured so as to allow treatment liquid to flow from the treatment liquid container into the downstream region when the treatment liquid container is connected to the treatment liquid input port.

14. The apparatus of claim 13, wherein the constriction is a tapered constriction with an opening that varies over a length of the constriction.

15. The apparatus of claim 13, wherein the constriction is an annular constriction.

16. The apparatus of claim 13, wherein the treatment liquid container includes a collapsible treatment liquid compartment configured so as to collapse and thereby dispense treatment liquid into the treatment liquid outlet channel when water flows from the water inlet channel into a space within the treatment liquid container that surrounds the collapsible treatment liquid compartment.

17. The apparatus of claim 13, wherein at least one of the water inlet channel and the treatment liquid outlet channel is able to penetrate a membrane sealing the treatment liquid container when the treatment liquid container is attached to the treatment liquid input port.

18. The apparatus of claim 13, wherein at least one of the water inlet channel and the treatment liquid outlet channel is exchangeable, thereby allowing selection of channels of variable inner diameter so as to control the rate of flow of treatment liquid from the treatment liquid container.

19. The apparatus of claim 13, wherein at least one of the water inlet channel and the treatment liquid outlet channel includes a valve that enables control of the rate of flow of treatment liquid from the treatment liquid container.

20. The apparatus of claim 1, further comprising a water diverter configured so as to intercept a portion of the water flowing through the hose bib adaptor and divert the portion of the water into the water inlet channel.

21. The apparatus of claim 1, wherein the hose bib adaptor is configured so as to resist rotation relative to a hose bib when the hose bib adaptor is connected to the hose bib.

22. The apparatus of claim 1, wherein the hose bib adaptor includes a hose bib connector and a spring attached to the hose bib adaptor, the spring including an end that is insertable into an opening in the hose bib connector so as to resist rotation of the hose bib adaptor relative to a hose bib when the hose bib connector is connected to the hose bib.
